(19) United States
(12) Patent Application Publication
(10) Pub. No.: US 2019/0370729 A1
(43) Pub. Date: Dec. 5, 2019

(54) System, Method and Computer Program Product for Controlling, Creating, and Modifying Process Sequences

(71) Applicant: WIBOND Informationssysteme GmbH, Parkstein (DE)

(72) Inventor: Juergen MEIER, Parkstein (DE)

(21) Appl. No.: 16/544,385

(22) Filed: Aug. 19, 2019

Related U.S. Application Data
(63) Continuation of application No. PCT/IB2018/051134, filed on Feb. 23, 2018.

(30) Foreign Application Priority Data
Feb. 23, 2017 (DE) 10 2017 103 798.5

(51) Int. Cl. G06Q 10/06; G06F 13/362; G06F 9/451

(52) U.S. Cl. CPC G06Q 10/063116; G06F 3/04847; G06F 9/451; G06F 13/362

(57) ABSTRACT

A system for controlling, creating and modifying process sequences is disclosed. Furthermore, a method and a computer program product for creating and modifying process sequences are disclosed. The system comprises an IT area of a user with a plurality of data-providing and/or data-receiving elements. Likewise, a process area is provided, in which at least one process sequence is implemented, which is constructed from function modules and device modules. Execution modules composed of function modules and/or device modules are assigned properties and values. In a configuration area having at least one graphical user interface, a plurality of process sequences can be created and/or modified. A middleware comprising a plurality of services which is communicatively connected with the elements of the IT area, the process area and the configuration area.

### RELATED APPLICATIONS

This Application is a Continuation application of International Application PCT/IB2018/051134, filed Feb. 23, 2018, which in turn claims priority to German Patent Application DE 10 2017 103 798.5, filed Feb. 23, 2017, all of which are incorporated herein by reference in their entirety.

### FIELD OF THE INVENTION

The invention relates to a system for controlling, creating and modifying process sequences.

Furthermore, the invention relates to a method for creating and modifying logical process sequences.

Furthermore, the invention relates to a computer program product for creating and modifying logical process sequences.

### BACKGROUND OF THE INVENTION

German utility model DE 20 2013 005 733 U1, published on May 5, 2013, discloses a system for projecting or setting up a technical plant and/or an automation system for a technical plant. The system comprises a display device and operating elements, wherein various operating areas for various technical and/or logical components of the plant or automation system are provided on the display device. On the display device, a first operating area for a first component of the plant or of the automation system with first information about the component and/or input fields for setting technical or logical properties with respect to the component is displayed. A second operating area is provided for a second component of the plant or automation system with second information about the component and/or second input fields for setting technical or logical properties with regard to the component. A first operating element is provided for the system, and the system is set up and configured so that when operating the first operating element and the first operating area, the selection changes from the first operating area to the second operating area. A second operating element is provided for the system. The system is set up and configured such that, when operating the second operating element and the selected first operating area, the selection changes from the first operating area to a first input field within the first operating area.

German patent application DE 10 2015 214 742 A1, published on Feb. 9, 2017, discloses a system and a method for initializing applications for devices of an industrial plant of different device types. The different device types each require different initializations of an application. The system comprises a capture module configured to extract initialization requirements of the devices and centrally store them for the industrial plant. An instruction module is configured in such a way that, based on the extracted initialization requirements, uniform initialization commands are generated for one application each, which are used on a plurality of devices of the same device type. An initialization module is configured to apply the initialization commands to the respective application before they are applied on the device.

German patent application DE 10 2011 006 786 A1, published on Oct. 11, 2012, discloses a product that can be equipped with a product sensor, so that data of a plant or machine can be determined by means of the product sensor and the product. The determined data can be used for diagnosis and/or control of the plant or machine. In this case, it is advantageous that the data is produced at the location of the product and thus an undesired effect (for example, of environmental parameters or the plant itself) on the product can be determined directly. The product can be used, for example, in automation technology, plants or machines or in different variants of product manufacturing.

German patent application DE 198 12 377 A1, published on Sep. 23, 1999, discloses a system for the automated operation of a long goods warehouse, which ensures a simple operability in the first place, is also economically producible and operable and supports good scalability. The system is suitable for the automated management of a long goods warehouse and has a storage area with a plurality of storage locations, with at least one storage and retrieval station, which is stationary relative to the storage area, and at least one transport device for material movements of long goods between storage locations and storage and retrieval stations. A control device is provided for operating the transport device for material movements. Further, at least one computer connected with the control device is provided for managing the material in terms of storage location, material type, number of items and total material-type length, for capturing retrieval and storage orders, and for transferring the orders evaluated with regard to storage location, storage/retrieval station and movement operations to the control device.

### SUMMARY OF THE INVENTION

An object of the invention is to provide a system for controlling, creating and modifying logical process sequences, which has a high degree of flexibility, with which process sequences can be created as simply as possible. Likewise, it should be possible to easily integrate devices into the system at a later date without having to change the system.

This object is achieved by a system for controlling, creating and modifying logical process sequences, comprising:

an IT area of a user, the IT area having a plurality of data-providing and/or data-receiving elements;

a process area, in which the at least one process sequence is implemented, which is composed of a plurality of execution modules, which are composed of at least one selectable function module and/or at least one selectable device module;

a configuration area having at least one graphical user interface which is a monitor which is subdivided into at least a first subwindow and a second subwindow, the first subwindow comprising a plurality of selectable function modules and a plurality of selectable device modules, and in the second subwindow at least one process sequence can be created, modified and visualized from the plurality of selectable function modules and the plurality of selectable device modules; and

a middleware comprising a plurality of services communicatively connected to the data-providing and/or data-receiving elements of the IT area, the process area and the configuration area.

A further object of the invention is to provide a method for creating and modifying logical processes, which has a high degree of flexibility, so that different process sequences can be created or supplemented in a simple and cost-effective manner.

The above object is achieved by a method for creating and modifying process sequences, comprising the steps of:

creating or modifying at least one process sequence via a graphical user interface of a configuration area based on function modules and device modules, the process sequence being made up of a plurality of execution modules; wherein the creation and/or modification of each process sequence is carried out such that at least one function module and at least one device module are selected from at least one first subwindow and displayed as the execution module in at least one second subwindow;

connecting the execution modules of a process sequence via transitions in the second subwindow, so that the process sequence is defined;

transferring the at least one process sequence to the middleware and storing there; and

retrieving the at least one process sequence from the middleware for execution in a process area.

Furthermore, it is an object of the invention to provide a computer program product for creating and modifying logical process sequences, which has a high degree of flexibility, so that different process sequences can be created and supplemented in a simple and cost-effective manner.

This object is achieved by a computer program product for creating and modifying at least one process sequence of a warehouse logistics, a manufacturing logistics, or a manufacturing process, the computer program product having a plurality of program instructions stored on one or more computer-readable storage media, the computer program product, comprising:

at least one process sequence is defined on a graphical user interface on the basis of function modules and device modules stored in a middleware, wherein a plurality of execution modules are composed of the function modules and/or the device modules, which are interconnected via transitions;

the created process sequence is assigned to a process area and the middleware is communicatively connected to the process area; and

data from the at least one process sequence of the process area are sent via the middleware to data-providing and/or data-receiving elements of an IT area of a user, and data from the elements of the IT area are retrievable via the middleware from the at least one process sequence of the process area.

In an embodiment of the invention, the system for controlling, creating and modifying process sequences is subdivided into a plurality of areas. A user area (IT area) comprises a plurality of data-providing and/or data-receiving elements. These elements can be, for example, databases, software services or higher-level IT systems. In an embodiment of the invention, a process area is communicatively connected (via suitable interfaces) to a middleware. In the process area at least one process sequence is implemented, which is composed of execution modules and device modules. In a configuration area having at least one graphical user interface, process sequences can be created and/or modified. The middleware, which comprises a plurality of services, is communicatively connected to the data-providing and/or data-receiving elements of the user area (IT area), the process area, and the configuration area.

In embodiments of the invention, the following services can be installed in the middleware.

Order Picking System:

Software for the administration and control of order picking displays, which can be assigned, for example, to racks, shelves, warehouses or storage shelves. The order picking system comprises a server and a manager.

Manufacturing and Logistics Logic Module

In an embodiment of the invention, the manufacturing (production) and logistics logic module is a service in the middleware. The service is a generic software for creating cross-platform logical process sequences for manufacturing and logistics tasks. The service enables the creation of complex, logical process sequences by modules. The process sequences can be created by a client and executed by the service. The service is essentially composed of two parts: devices and process sequences. Devices are, for example, displays or monitors, operating units of warehousing or order picking, 1D/2D bar code scanners, etc., which can be set up (configured) once on a server. For each process sequence, the required devices can be retrieved and used by the server. In this case, parameters, for example, IP address, port or start character of the devices used are defined. The process sequences are composed of functions which are connected by arrows (transitions). These transitions indicate the chronological order of the functions. Functions perform small tasks and, if necessary, can access the configured devices. Examples include comparing values, sending text to at least one display or monitor, or waiting for an acknowledgment button to be pressed on an operating unit.

By means of the services installed in the middleware, it is possible to create the process sequences for the process area and to realize the resulting modifications easily and quickly in the process sequence.

In an embodiments of the invention, the execution modules are composed of function modules and/or device modules which are connected to one another via transitions. The graphical user interface (for creating and parameterizing the process) is a software that optionally runs on a separate computer and which is displayed on its monitor and operated via its input devices (for example, keyboard and/or mouse). The monitor is subdivided into at least a first subwindow and a second subwindow. The first subwindow comprises a plurality of selectable function modules and a plurality of selectable device modules. In the second subwindow, different process sequences, which are composed of a plurality of execution modules, can be created, modified and visualized from the plurality of selectable function modules and the plurality of selectable device modules. If a function module or a device module has been dragged into the second window, these modules become a execution module, on which base on which base these function modules and device modules are now parameterized specifically for the desired process sequence.

In an embodiment of the invention, the devices, such as monitors, databases, 1D bar code scanners, 2D bar code scanners, order picking displays (operating units), PLC etc. are set up (configured) once in the middleware and can be used from any process sequence. In this case, parameters, for example, IP address, port or start character are defined. The devices enable the communication with the middleware or the services of the middleware. Thus, monitors, LED displays or order picking systems can be controlled. The incomplete and thus exemplary list of supported devices is growing steadily. Devices such as network server/client, e-mail, SMS module, databases (ODBC/SQLite/Sybase/Oracle/MySQL), LED displays, OPC UA servers, PickVision servers, 1D/2D bar code scanners (with COM Interface or Ethernet), etc. may be provided.

In an embodiment, if a device is configured in the manufacturing (production) and logistics logic module, i.e. the middleware, all process sequences that run on it can access this device. In an embodiment, simultaneous access from different, running process sequences is also possible. In embodiments, there are different function modules available for each device type. A configured 1D/2D bar code scanner, for example, only provides a function “read bar code” while a database provides functions for reading, inserting, and updating tables of data generated by a process sequence.

In an embodiment, each of the created process sequences consists of one master and at least one slave. A master is always required if one of the slaves cannot communicate with the middleware via Ethernet. In the event that a master is provided, the master comprises a plurality of interfaces, by means of which the required slaves are connected to the master. The master is connected via a suitable interface to at least one service of the middleware. Each master receives the generated and/or modified process sequences by means of a service of the middleware. The process sequences can be executed by means of the master. The slaves are the collective term for operating units for the removal, operating units for the subsequent delivery or other devices required in the process sequence.

Each process sequence may be assigned at least one slave that provides an input and at least one slave that provides an output. As mentioned above, if the slaves use a communication protocol that does not allow direct communication with the middleware, the slaves may be communicatively connected with the middleware by means of the master. The master comprises a plurality of interfaces, by means of which the slaves are connected to the master and the master is connected to the middleware. The interfaces comprise, for example, GPIOs, serial interfaces, ProfiNet, ProfiBus or WLAN.

The method according to the invention for creating and modifying process sequences first comprises creating and/or modifying at least one process sequence via a graphical user interface. The graphical user interface is provided in a configuration area. The creation and/or modification of process sequences can be carried out on the basis of the function modules and device modules stored in a middleware. The at least one process sequence of a plurality of execution modules is transferred to the middleware (at least one service) and stored there. For execution, the at least one process sequence is retrieved from a process area from the middleware.

In an embodiment, the created and/or modified process sequences are transferred to the middleware (service) at the push of a button. The process sequences can therefore be created as simply as possible, since all the components used and also the other devices are configured independently of the middleware. If the devices are already reachable at the time of sequence creation (creation of a process sequence) (i.e. wired, IP addresses are assigned, etc.), this further simplifies the process of creating a process sequence.

The creation and/or modification of each process sequence is performed in such a way that at least one function module and at least one device module (device) can be selected from at least one first subwindow. The function modules and device modules are displayed in at least one second subwindow. The at least one function module and the at least one device module are connected to each other via at least one transition. The properties of the function modules and device modules that become execution modules are selected in a third subwindow. The execution modules are connected with each other by means of the at least one transition. The execution module decides when and under which conditions which transition will be executed. The transition itself only describes the “path” from the output of a execution module to the input of the next execution module.

The transitions used are represented by simple arrows. These arrows can either be selected from the user interface by right-clicking on a function in the appearing context menu (subwindow), or by holding down the Alt key and dragging the arrow from one function to the other. Subsequently, it is to be selected, when this transition shall be executed. This is realized by events, i.e. events that trigger the functions under certain conditions. For example, the if-else function can have at least two events:
True event: triggered when the condition is true;
False event: triggered when the condition is not true.

In embodiments of the invention, the plurality of selectable device modules comprise a plurality of input devices and a plurality of output devices, wherein the input devices and the output devices are assigned to a plurality of parameters, for example, IP address, port or start character. The input devices and the output devices of a process sequence can, as already mentioned, be communicatively connected to a master. For this purpose, the master can comprise a plurality of interfaces, by means of which the input devices and the output devices, if necessary, can be connected to the master and the master to the middleware.

The computer program product according to the invention for creating and modifying process sequences comprises a plurality of program instructions stored on one or more computer-readable storage media. The computer program product is characterized in that on a graphical user interface, at least one process sequence can be defined on the basis of function modules and device modules stored in a middleware. The execution modules are composed of the parameterized function modules and the device modules, which are interconnected via transitions. The created process sequence is assigned to a process area, wherein the middleware is communicatively connected to the process area. Data from the at least one process sequence of the process area is sent via the middleware to elements of a user area (IT area). Data from the elements of the user area can be retrieved via the middleware from the at least one process sequence of the process area.

One workplace, such as a workplace of a manufacturing island, can be controlled with an associated, created and/or modified process sequence. In an embodiment, at least one display (not necessarily) is assigned to the respective workplace, on which display a plurality of status messages and/or work instructions for the workplace are displayed to a user. The display is communicatively connected to the middleware, at least by means of interfaces.

For the reasons mentioned above, the following requirements are imposed on the new computer program product, which cooperates with the system according to the invention and the method according to the invention. Some flexibility must be ensured, i.e. with the same software, different process sequences shall be created without having to modify the software itself.

The software must be extensible, for example for new terminal devices or logic. Even users who have no programming skills should be able to create and/or modify a process sequence due to a certain degree of simplicity. This allows the customers or users themselves to realize their ideas of the system and adapt it to changing conditions.

By dividing the software (middleware) in server and client, for example, the server part of the application can constantly run on a server computer, while the client software must be started only in case of changes. The server executes the system and the client consists of the operating interface (user interface) for creating and modifying the process sequences. This parallelism must be available, so that also larger process sequences, such as a plurality of worker guidances (a plurality of workplaces) can be displayed at the same time.

Likewise, according to the invention, a plurality of the execution modules assembled to form a process sequence can be combined to form a template. These templates can be stored for later use. This has the advantage that for a later use, the process sequence existing due to the template does not have to be created again.

### BRIEF DESCRIPTION OF THE DRAWINGS

In the following, embodiments of the invention and their advantages with reference to the accompanying figures will be explained in more detail. The proportions in the figures do not always correspond to the actual size ratios, as some shapes are simplified and other shapes are shown enlarged in relation to other elements for ease of illustration.

FIG. 1 shows a plan view of an embodiment of a manufacturing island and the assignment to a warehouse for components in a schematic view.

FIG. 2 shows a schematic view of a manufacturing with a plurality of manufacturing islands.

FIG. 3 shows a view of an order picking display, such as used in a shelf that is equipped with a “pick-to-light” system.

FIG. 4 shows an exemplary view of a shelf with a plurality of containers for components, the removal or deposit is controlled by a bar code.

FIG. 5 shows an exemplary view of another embodiment of a shelf with a plurality of containers for components, wherein the removal or deposit is controlled by means of an optical intervention monitoring.

FIG. 6 shows a schematic view of the integration of the middleware according to the invention in the creation, control and monitoring of process sequences in a dynamic warehousing.

FIG. 7 shows a schematic view of the configuration of a dynamic warehouse management and the simplicity with respect to changes and additions by means of the middleware.

FIG. 8 is a schematic view of a system for controlling process sequences of various kinds.

FIG. 9 is an enlarged view of the schematic view of the manufacturing process of FIG. 8.

FIG. 10 is an enlarged view of the schematic view of a process of the manufacturing logistics of FIG. 8.

FIG. 11 is a schematic view of an embodiment of the graphical user interface for creating and/or modifying process sequences.

FIG. 12 is a schematic view of the integration of a monitor for process visualization in a control of a process sequence in manufacturing.

FIG. 13 shows a schematic view of an embodiment of the monitor for displaying the various information and/or from a process sequence.

FIG. 14 is an activity diagram of an exemplary process sequence in the application.

### DETAILED DESCRIPTION OF THE PREFERRED EMBODIMENTS

For identical or equivalent elements of the invention, identical reference numerals are used. Furthermore, for the sake of clarity, only reference symbols are shown in the figure which are necessary for the description of the figures. The illustrated embodiments merely represent examples of how the system according to the invention, the method according to the invention and the computer program product according to the invention can be configured for the control, creation, modification and visualization of process sequences. Thus, it should not be construed as a final limitation of the invention.

According to one possible embodiment, the invention is frequently used in the so-called “worker guidance” application. This means that the worker is guided in his/her work by the method according to the invention and process steps are visualized and verified.

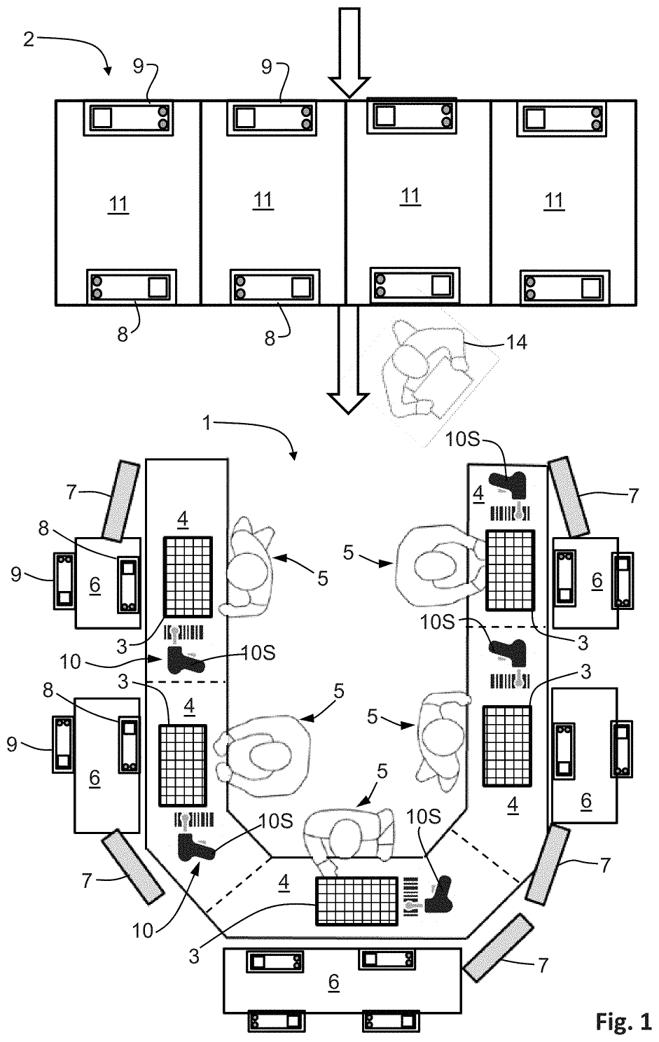

FIG. 1 shows a plan view of an embodiment of a manufacturing island 1 for manufacturing a product 3. The manufacturing island 1 is associated with a warehouse 2 (storage) for components that are needed in the manufacturing and supplied to the manufacturing island 1. In the illustration shown here, the manufacturing island 1 comprises five workplaces 4. It is obvious that the configuration of the manufacturing island 1 cannot be construed as a restriction. The manufacturing island 1 may be configured as needed for the manufacturing of the product 3. At each of the five workstations 4 works a worker 5. Each workstation 4 may be assigned at least one storage rack 6 (storage shelf), from which the components to be installed can be removed and in which the components to be installed are replenished from a warehouse 2 (storage). The warehouse 2 may also be used with new components to be processed. Also, in this embodiment, each workstation 4 is assigned a display 7, via which the worker 5 can output work instructions, display statistics of the manufacturing process and, if necessary, also make entries. Via the display 7, the workers 5 are accompanied in manufacturing sites as comprehensibly as possible by the manufacturing processes. For the displays 7, on which a corresponding software is running, dynamically generated information (such as text, video, tables, time, etc.) is displayed. For completeness, it should be mentioned here that the embodiment described here cannot be construed as limiting the invention. For example, it is not required that each workstation 4 is associated with a display 7. Displays 7 are assigned to the workplace 4 only if a worker 5 requires a corresponding visual guidance of the process.

The objects shown on the display 7 (text, image, video) can be changed via a network. Also audio files or text to be spoken can be output. In the illustrated embodiment, each storage rack 6 is associated with an operating unit 8 for the removal and an operating unit 9 for the subsequent delivery of the components. Furthermore, each workstation 4 may be associated with a device 10, which may be a 1D/2D bar code scanner 10S at each of the workstations 4. It will be understood by one skilled in the art that not all devices 10 need to be 1D/2D bar code scanners 10S. Depending on the requirements of the workplace 4, the required devices 10 are used. With the 1D/2D bar code scanner 10S, the worker 5 can scan 1D bar codes or 2D bar codes which are assigned to the components of the products 3 to be processed or the manufacturing status of the product 3 at the respective workstation 4. In the following description, for the sake of simplicity, the term bar code will be used synonymously for a 1D bar code or a 2D bar code.

In the manufacturing process described in FIG. 1, a guidance of the workers 5 for five workstations 4 is required. These workstations 4 are passed through by products 3 sequentially. The workflow at each of the workstations 4 is very similar. Upon receipt of the product 3 to be manufactured (from a previously traversed workstation 4 or warehouse 2), the worker 5 reads the corresponding bar codes 12 (see FIG. 4) with the 1D/2D bar code scanner 10S. The work instruction for the product 3 is displayed on the display 7 and the corresponding operating units 8 for the removal of the required components light up. If the worker 5 has followed the work instructions, he/she pushes the product 3 to the next workstation 4 (station) where the product 3 is being processed by another worker 5.

By the mentioned operating units for removal 8, the system can detect whether new components that the workers 5 process in the manufacturing island 1 are required. If this is the case, a requirement message is sent to another worker 14, who refills the storage racks 6 from the back with the corresponding components. Via the operating unit 9 for the subsequent delivery of the components, the refilling of the storage racks 6 can be confirmed. Attention is thus focused on the independent processing at the individual workstations 4 and the requirement messages from the workstations 4. The required data, such as bar codes, work instructions and the associated operating units 8 for the removal or the associated operating units 9 for the subsequent delivery are stored in a database and have to be read out of it.

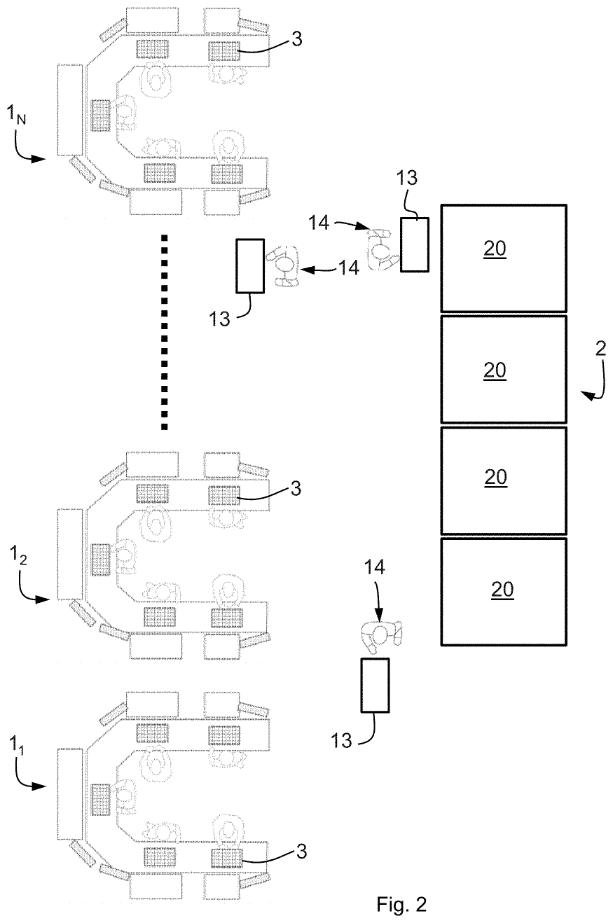

FIG. 2 shows a schematic view of a manufacturing with a plurality of manufacturing islands 11, 12, . . . , 1N. Each of the manufacturing islands 11, 12, . . . , 1N is assigned a process sequence, according to which the manufacturing or partial manufacturing of a product 3 is carried out. For example, the requested components for the products 3 are taken from a warehouse 2 and supplied to the individual manufacturing islands 11, 12, . . . , 1N with a shelf trolley 13. The warehouse 2 is divided into a plurality of racks 20 (shelves) having individual compartments (shelves) (not shown here). The compartments are assigned operating units 8 for the removal or the associated operating units 9 for the subsequent delivery (not shown here).

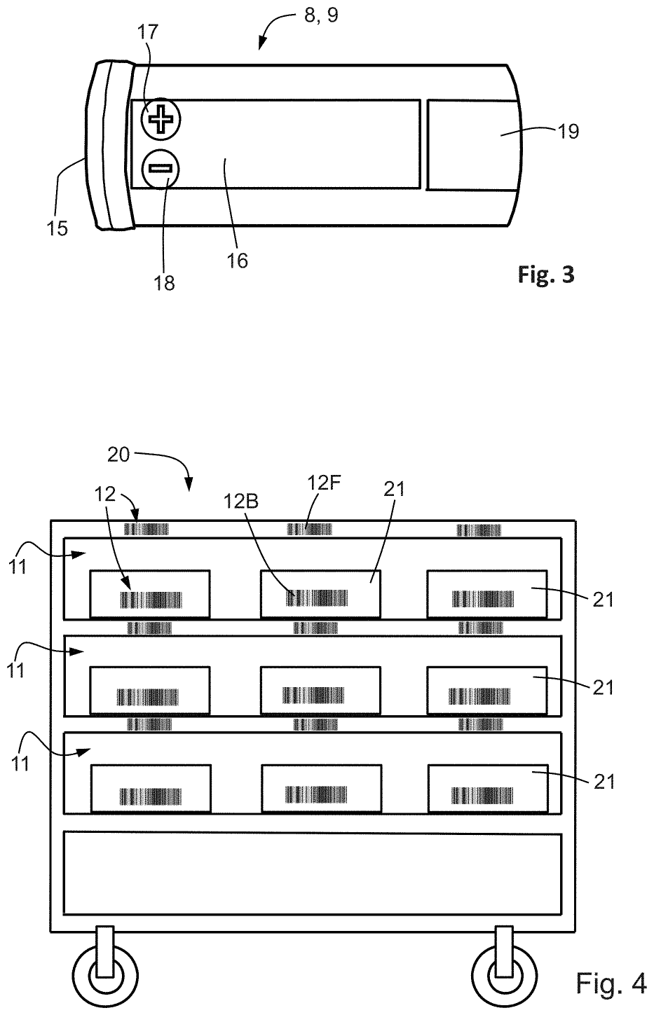

FIG. 3 shows an embodiment of an operating unit 8 or 9, as it can be used in the system according to the invention. The operating unit 8 or 9 (order picking display) has, for example, a colored light ring 15, by means of which the worker 5 or worker 14 (not shown here) is displayed, for example, whether he/she should perform a removal or a subsequent delivery at the compartments associated with the respective operating units 8 and 9. In embodiments, likewise, each operating unit 8 or 9 comprises a display 16 for displaying information. Preferably, the display 16 is bright and very easy to read. Depending on the display type, an animation of the display, that means, for example, a stationary lettering, a flashing lettering and/or a ticker, is possible. An increment button 17 (key), decrement button 18 (key) and an acknowledgment button 19 (key) are provided on the operating unit 8 and 9, respectively. The key or button assignment of the increment button 17, the decrement button 18 and the acknowledgment button 19 are freely programmable.

An exemplary embodiment of a rack 20 with a plurality of containers 21 for components is shown in FIG. 4, wherein the removal or deposit is controlled by means of a plurality of bar codes 12. Thus, a bar code 12F is assigned to the respective position of the container 21 in the compartment 11. Another bar code 12B is assigned to the container 21 for the corresponding components. On the display 7 of the respective workplace 4, the worker 5 receives the instruction from which container 21 of the rack 20, he/she should remove the component or components (not shown here). With the 1D/2D bar code scanner 10S (see FIG. 1), the user first scans the bar code 12F for the position of the rack 20 and then the bar code 12B assigned to the container 21 at the respective position on the rack 20. The consistency is checked by a software and displayed to the worker 5. This ensures that the right components are available for the current work step.

FIG. 5 shows another possible embodiment of a rack 20 with a plurality of containers 21 for components from which the components can be fed in a regulated manner to a manufacturing process. As already mentioned in the description of FIG. 1, the worker 5 scans a bar code 12B of the container with the 1D/2D bar code scanner 10S in the respective working area. Depending on the scanned bar code 12B, he/she receives work instructions on a display 7 on the work area 4. The worker 5 then removes the corresponding components from the compartments 11 of the storage rack 6 (not shown here). Each of the compartments 11 is associated with an operating unit 8 for the removal, which indicates by a light signal from which container 21 the components must be removed. By a light cone 22, associated to the container 21, is checked whether the worker 5 engages in the right container 21. With the scanning of the bar code 12B on the container 21, the worker 5 acknowledges the removal of the component from the container 21. With the system according to the invention, a different arrangement or number of containers 21 can be programmed in a simple manner.

The embodiments of the devices 10, operating units 8 or 9 shown in FIGS. 1 to 5 and the process sequences illustrated by way of example only serve to describe and to understand the invention. With the invention, it is possible to present or visualize any process sequences with any number of devices and functionalities in a simple manner.

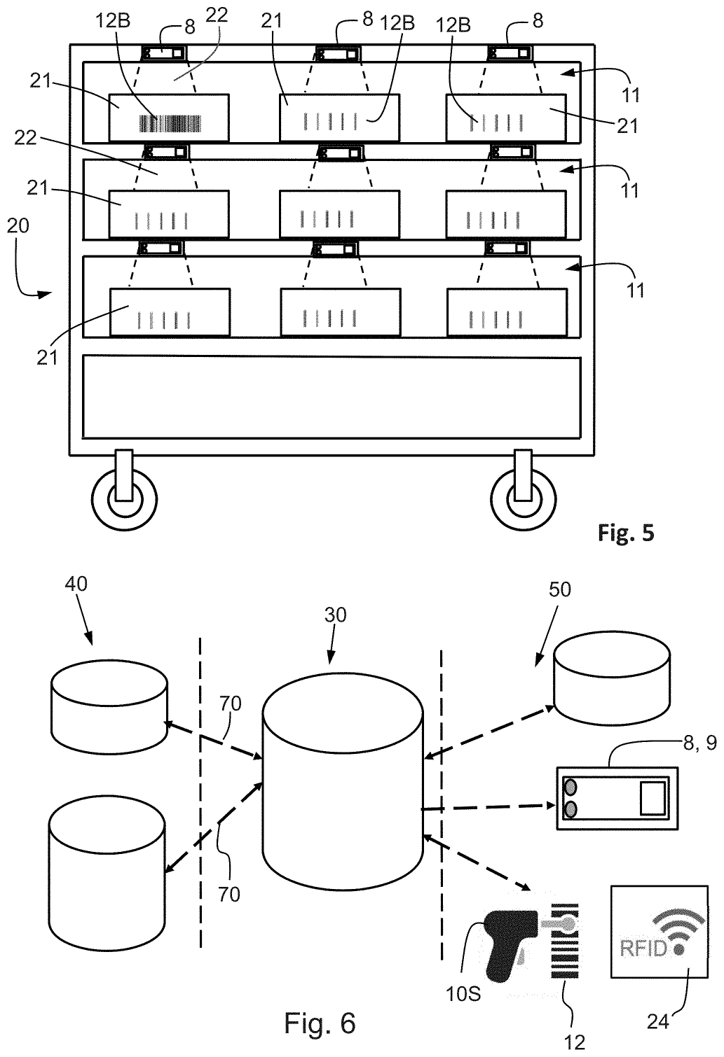

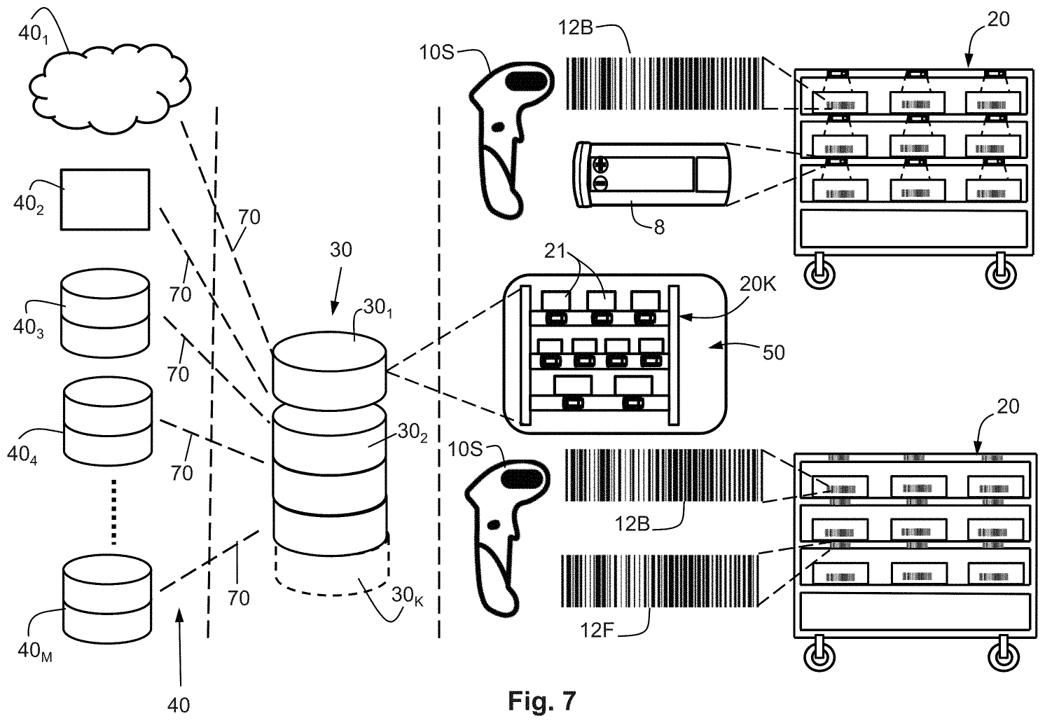

FIG. 6 shows a schematic view of the integration of the middleware 30 according to the invention in the creation, control and monitoring of process sequences on the side of the process area 50. The process area 50 in this exemplified embodiment is a dynamic storage. In an IT area 40 of a customer (user) databases, software services, higher-level IT systems, etc. are provided. In the dynamic storage embodiment illustrated here, a plurality of elements 40₁, 40₂, . . . , 40_{M} (see FIG. 7) are provided in the IT area 40 of the customer (user), the services. For example, the elements 40₁, 40₂, . . . , 40_{M} comprise an SAP system (or service similar to SAP), scheduler software, etc., and databases. The services and the databases are connected to the middleware 30 via interfaces 70. On the process area 50, the devices required for dynamic storage are provided. The devices may comprise, for example, the operating units 8 for the removal, the operating units 9 for the subsequent delivery, at least one 1D/2D bar code scanner 10S or an RFID system 24.

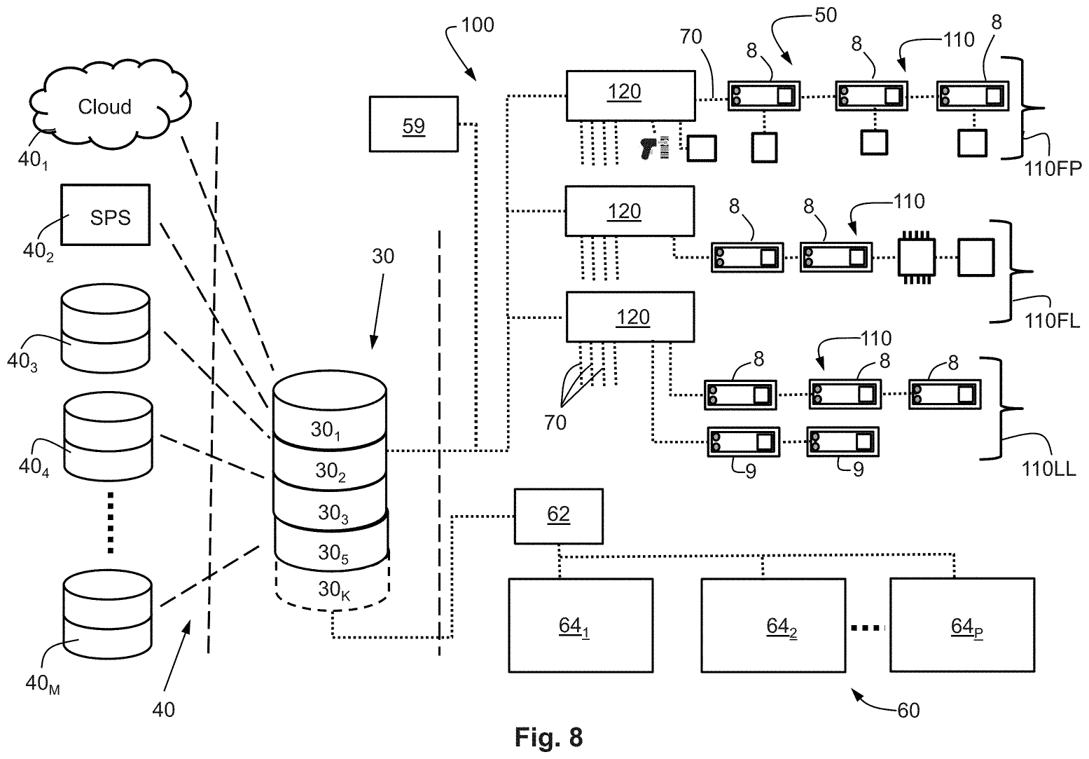

FIG. 7 shows a schematic view of the configuration of a dynamic warehouse management (dynamic inventory/stock management) and the simplicity with respect to changes (modifications) and additions by means of the middleware 30. The middleware 30 comprises a plurality of services 30₁, 30₂, . . . , 30_{K}, which may be called to create process sequences and for configuration. At least one of the services 30₁, 30₂, . . . , 30_{K} can be used for creating process sequences in warehouse logistics. In the exemplary embodiment shown in FIG. 7, a procedure for warehouse management (storage and/or removal) can be created with the PVS (abbreviation for “ProView-Software”) from the middleware 30. The PVS comprises services, a graphical user interface 62 (see FIG. 8), and a configurator. Data for the planning of the process sequence (planner data) in warehouse management are transferred from the IT area 40 of the customer to the middleware 30. Via the graphical user interface 62, a user can distribute the distribution of the containers 21 for the components required in a manufacturing process, in a configured rack 20K, as desired (according to process-optimized conditions). This distribution of the containers 21 can then be assigned to the racks 20 with the 1D/2D bar code scanner 10S and the operating unit 8 or the 1D/2D bar code scanner 10S alone. The bar code 12B on the container 21 identifies the components in the container 21.

When the rack 20 at the position of the container 21 is provided with an operation unit 8 for the removal, the bar code 12B of the container 21 is scanned with the 1D/2D bar code scanner 10S and the acknowledgment button 18 of the operation unit 8 is pressed (not shown here). Thus, the respective container 21 is associated with the corresponding components of a defined position on the rack 20. The new assignment can then be automatically transferred to a service, for example, SAP, on the user area 40.

According to another embodiment, the rack 20 at the position of the container 21 has an operating unit 8 for the removal and a light cone 22 projected by a detector unit (not shown). For the assignment of the position of the container 21 on the rack 20, the bar code 12B of the container 21 is scanned with the 1D/2D bar code scanner 10S, the acknowledgment button 18 of the operating unit for the removal 8 is pressed and it is gripped through the light cone 22 into the container 21. Thus, the respective container 21 is associated with the corresponding components of a defined position on the rack 20. The new assignment can then be automatically transferred to a service, for example, SAP, on the user area 40.

According to a further embodiment, the rack 20 has at the position of the container 21 a bar code 12F which represents the position of the container 21 in the compartment 11. For the assignment of the position of the container 21 on the rack 20, the bar code 12B of the container 21 is scanned with the 1D/2D bar code scanner 10S. Likewise, the bar code 12F of the compartment position is scanned with the 1D/2D bar code scanner 10S. Thus, the respective container 21 is associated with the corresponding components of a defined position on the rack 20. The new assignment can then be automatically transferred to a service, for example, SAP, on the user side 40.

FIG. 8 shows a schematic view of a system 100 for controlling at least one process sequence 110. The process sequences 110 may differ. The system 100 essentially consists of an IT area 40 of the customer, a middleware 30, a process area 50 and a configuration area 60. The process area 50 and the configuration area 60 are each connected to the middleware 30 via a network. The middleware 30 is also communicatively and bidirectionally connected to the IT area 40 of the customer.

The IT area 40 of the customer comprises a plurality of elements 40₁, 40₂, . . . , 40_{M} from which the middleware 30 fetches data or supplies data to the middleware 30. The elements 40₁, 40₂, . . . , 40_{M} comprise databases such as Cloud, higher-level IT systems such as ERS, Manufacturing Execution System (MES), just-in-time prosuction (JIT) or manufacturing controls, for example, Programmable Logic Controller (PLC).

The middleware 30 comprises a plurality of services 30₁, 30₂, . . . , 30_{K}, which communicate with the elements 40₁, 40₂, . . . , 40_{M} of the customer's IT area 40 and the process area 50 and the configuration area 60.

The process area 50 comprises at least one process sequence 110. A process sequence 110 may, according to the exemplary embodiment illustrated here, be a warehouse logistics 110LL, a manufacturing logistics 110FL or a manufacturing process 110FP.

The warehouse logistics 110LL is configured such that a plurality of operating units 8 for the removal and a plurality of operating units 9 for the subsequent delivery to the compartments (not shown here) of a warehouse are mounted. By means of the operating units 8, 9, the worker is instructed for performing the deposit and removal precise and correct in position. Incorrect deposits or removals can be documented. If necessary, compartments of the warehouse can be assigned as desired. The new assignment must be documented only in the process sequence 110.

The manufacturing logistics 110FL is configured such that a plurality of operating units 8 for the removal of a supply rack 6 are assigned to a workstation 4. A worker 5 receives the instruction as to which components he/she should remove from the compartments 11. The removal is acknowledged by means of the operating units 8. A control of the correct removal is also given.

The manufacturing process 110FP is configured such that a plurality of operating units 8 are provided for the confirmation of executed and possibly controlled work steps.

The configuration area 60 allows process sequences 110, such as the warehouse logistics 110LL, the manufacturing logistics 110FL or the manufacturing process 110FP, to be generated and/or modified for the process area 50. For this purpose, the configuration area 60 comprises a graphical user interface 62 that is, for example, connected to at least one device for visualization 64₁, 64₂, . . . , 64_{P}. Devices for visualization 64₁, 64₂, . . . , 64_{P} are, for example, monitors, LED displays or touch screens of various kinds.

The middleware 30 may be assigned a monitor for process visualization 59, which serves to display diverse information and/or data from or for a process sequence 110 or process sequences 110.

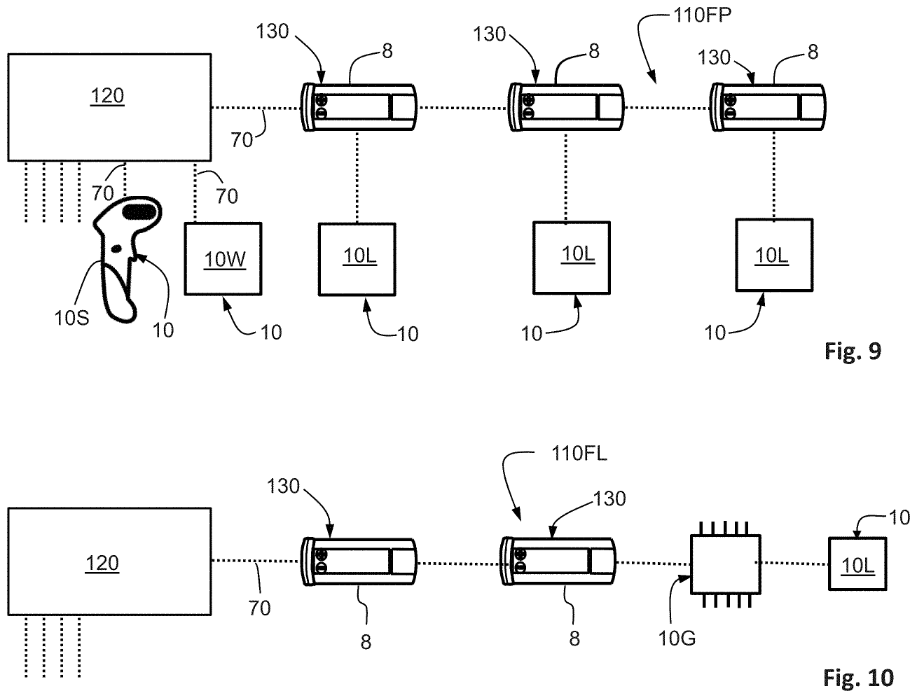

FIG. 9 is an enlarged view of the schematic view of the manufacturing process 110FP of FIG. 8. The manufacturing process 110FP shown here may be used, for example, at one of the workstations 4 of the manufacturing island 1 (see FIG. 1). For the manufacturing process 110FP shown here devices 10 such as a scale 10W and a 1D/2D bar code scanner 10S are used. The operating units 8 can be assigned, for example, a light barrier or a light sensor 10L as a device 10. By means of the light barrier or the light sensor 10L, for example, it can be confirmed that a work step on a product 3 is completed. Via corresponding interfaces 70, the devices 10 of the manufacturing process 110FP are connected to the master 120. The connection of the devices 10 to the master 120 is only required if the integrated devices 10 and/or the operating units 8 are not able to communicate directly with the middleware 30 via Ethernet. As described in FIG. 8, the master 120 is communicatively connected to the middleware 30 (not shown here).

FIG. 10 is an enlarged view of the schematic view of another process 110 of the manufacturing logistics 110FL from FIG. 8. For example, the manufacturing logistics 110FL, as shown here, can be used at one of the workstations 4 of the manufacturing island 1 (see FIG. 1). Here too, operating units 8 are connected to the master 120, in case they are not able to communicate directly with the middleware 30 via Ethernet. For example, the operating units 8 can be actuated when removing a component from a rack 20 (see FIG. 1) assigned to the workplace. One of the operating units 8 may be assigned a general purpose input/output (GPIO) 10G as a device. Additional devices 10 can be connected to the contacts of the GPIO. With the manufacturing logistics 110FL, track of the components required for a manufacturing process can be kept and a reordering with the warehouse logistics 110LL can be initiated on time.

It should be emphasized again that the embodiments of the illustrated process sequences 110 shown in FIGS. 9 and 10 are merely for the purpose of describing selected examples and are not intended to limit the subject matter of the invention. For example, process sequences 110 are conceivable in which all devices 10 and/or operating units 8 or 9, which may be referred to as slaves 130, communicate via a master 120 with the middleware 30. Likewise, process sequences 110 are conceivable in which some of the devices 10 and/or operating units 8 or 9 communicate with the middleware 30 via a master 120 and other devices 10 and/or operating units 8 or 9 communicate directly with the middleware 30 via Ethernet. Furthermore, process sequences 110 are conceivable in which all devices 10 and/or operating units 8 or 9 communicate directly with the middleware 30 via Ethernet.

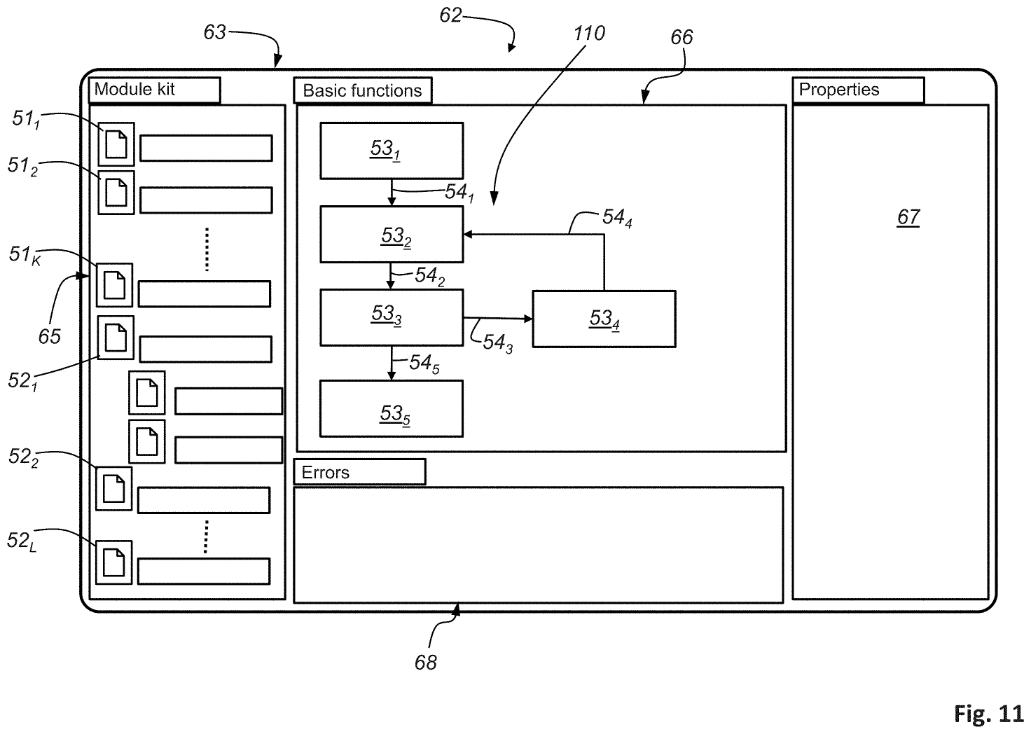

FIG. 11 shows a schematic view of an embodiment of the graphical user interface 62 for creating and/or modifying process sequences 110. For this purpose, a monitor 63 is subdivided into at least a first subwindow 65 and a second subwindow 66. The first sub-window 65 comprises a plurality of selectable function modules 51₁, 51₂, . . . , 51_{K} and a plurality of selectable device modules 52₁, 52₂, . . . , 52_{L}. In the second subwindow 66, from the selectable function modules 51₁, 51₂, . . . , 51_{K} and the selectable device modules 52₁, 52₂, . . . , 52_{L}, different process sequences 110 can be created, modified and visualized, which are composed of execution modules 53₁, 53₂, . . . , 53_{I}. The execution modules 53₁, 53₂, . . . , 53_{I} are composed of the function modules 51₁, 51₂, . . . , 51_{K} and the device modules 52₂, 52₂, . . . , 52_{L}, which are parameterized for the creation of the process sequences 110. In a third subwindow 67, the execution modules 53₁, 53₂, . . . , 53_{I} selected in the second subwindow 66 can be parameterized. The execution modules 53₁, 53₂, . . . , 53_{I} are assigned values and properties that are required for the respective process 110.

The execution modules 53₁, 53₂, . . . , 53_{I} are interconnected via transitions 54₁, 54₂, . . . , 54_{J} in the graphical user interface 62. The transitions 54_{I}, 54₂, . . . , 54_{J} define the sequence (order) in the process sequence 110. In a fourth subwindow 68, error messages can be displayed when creating a process sequence 110.

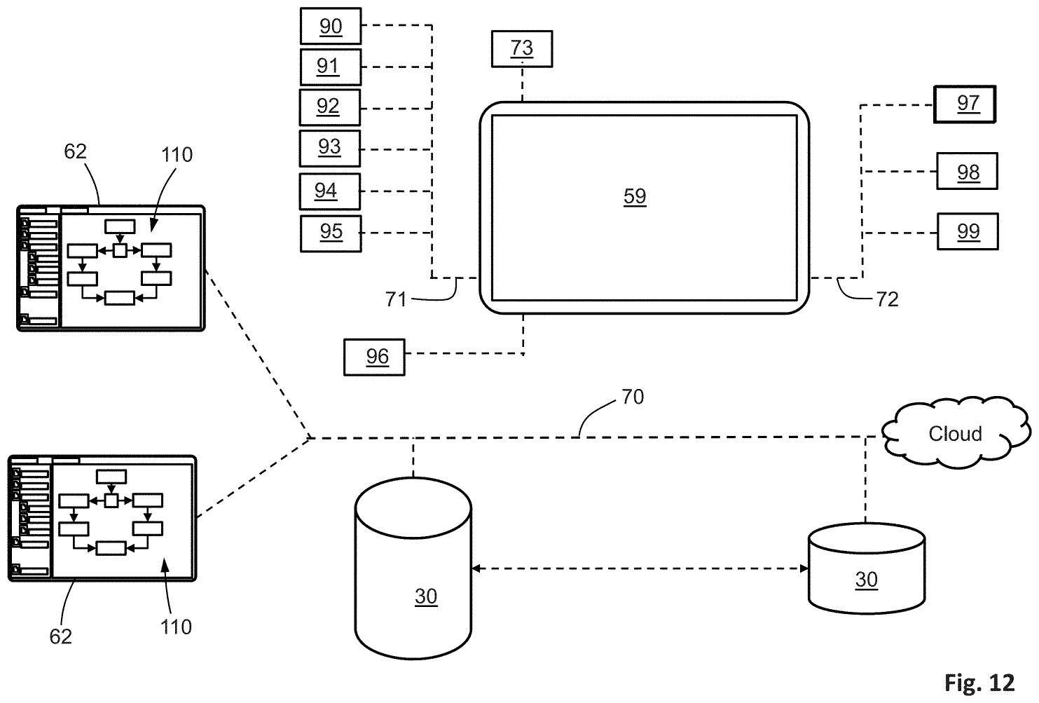

FIG. 12 shows a schematic view of the integration of a monitor 59 for controlling a process sequence 110 in manufacturing. The process sequence 110 or the work preparation can take place on at least one graphical user interface 62. The created process sequences 110 are stored in the middleware 30 in a corresponding database (service) or the cloud. The connection of the database (service) of the middleware 30 to other services of the middleware 30 takes place optionally via: XML/ASCII, ODBC, socket streams, or iDoc or RFC. With the other services of the middleware 30, a control of the monitor 59 can be performed, so that a central administration of the visualizations can be carried out. For this purpose, data connections to the IT area 40 of the customer (customer interface) and a connection to other services of the middleware 30 are provided.

The monitor 59 is connected to the middleware 30 and the cloud via a suitable interface 70. The monitor 59 is connected via an input 71 with, for example, a light barrier 90, a Profinet/Profibus 91, a potential-free inlet 92, an RFID 93, an A/D converter 94 or a PLC 95. Likewise, the monitor 59 may be assigned to a modem 96. The outputs 72 of the monitor 59 may be a visual signal generator 97, a speaker 98, or a potential-free outlet 99. The monitor 59 has also a WLAN communication 73.

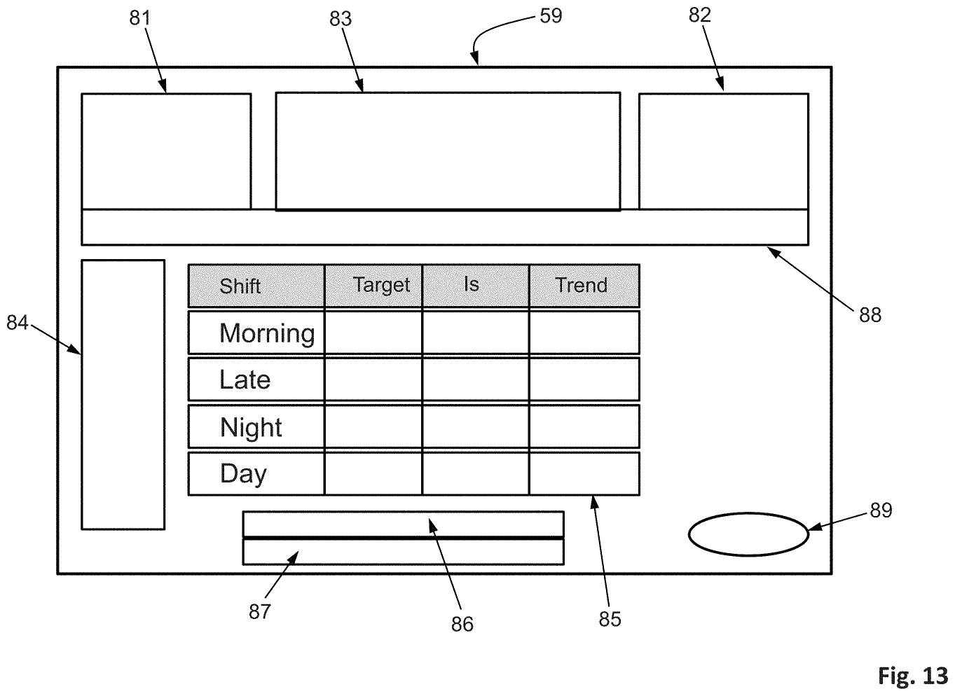

FIG. 13 is a schematic view of a possible embodiment of the monitor for the process visualization 59 to visualize diverse information and/or data from or for a process sequence 110. For example, for visualization, web pages 81 from the Internet, the intranet or news ticker can be integrated on the monitor 59. Likewise, videos 82 for assembly instructions or safety instructions can be integrated. Also a field 83 can be integrated for displaying any information, such as text, images, date and/or time, are involved. On the monitor 59, the dynamic cycle time 84 can be displayed in a freely scalable area. In a table 85 evaluations regarding the effectiveness of the individual daily shifts can be displayed. In a first status message field 86, information about the switching inputs of a PLC or light barriers can be shown. In a second status message field 87, status messages about analog/digital signals and the connection of peripherals such as signal lamps or speakers are displayed. In an information field 88, a freely editable online text, such as fault messages or general information can be given. Image data 89 may be integrated in the form of pixel or vector based graphics formats, for example, BMP, JPG or GIF.

A suitable software allows the user free and application-specific creation and management of dynamic presentations for the monitor 59. For example, the worker is displayed the information and instructions for the manufacturing process on the monitor 59. A graphical user interface is used for the free creation of dynamizable templates. On the configured monitor 59, which may be divided into a plurality of areas, for example, web pages and/or videos, dynamic cycle time scales, statistics, graphics, etc. are integrated.

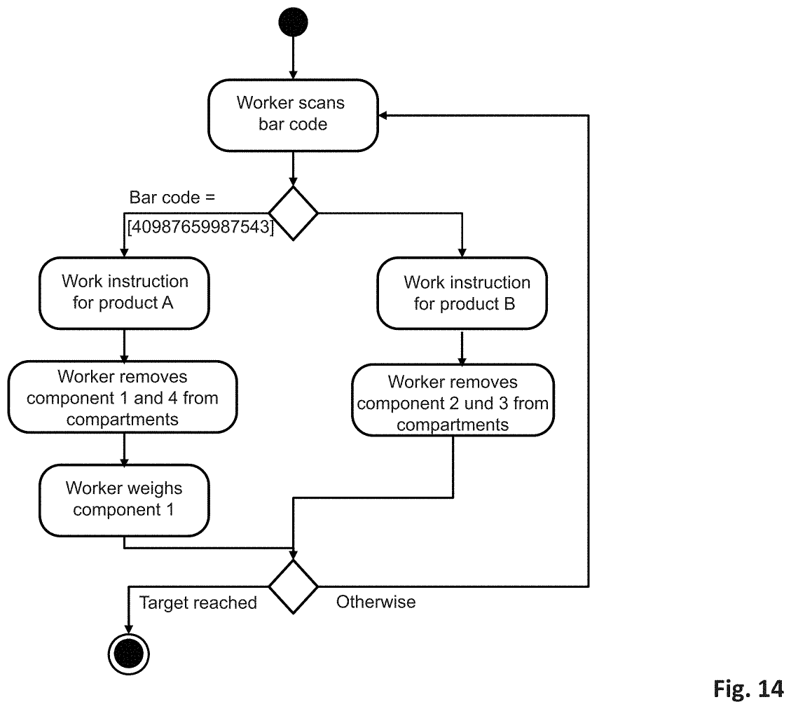

An example of a system according to the invention is shown in FIG. 14. The worker 5 scans a bar code 12 with a 1D/2D bar code scanner 10S (device 10) and, depending on the bar code 12, receives either the work instruction for building a product A or an instruction for assembling a product B. This work instruction is displayed on a monitor for process visualization 59. The worker 5 then removes the corresponding components from the compartments 11 of the storage rack 6, which compartments 11 are displayed to him/her, for example, by operating units 8 (see FIG. 5), and then he/she assembles the product A or B. When the worker has reached the target of, for example, 100 products, he/she must leave the workstation and the 1D/2D bar code scanner 10S is no longer needed. If the target is not yet reached, the worker should read in another bar code 12 and the process begins again.

The invention has been described in consideration of an embodiment. It will be understood by those skilled in the art that changes and modifications may be made without departing from the scope of the following claims.

### LIST OF REFERENCES

1 manufacturing island
3 warehouse, storage
3 product
4 workplace
5 worker
6 storage rack, storage shelf, supply rack
7 display
8 operating unit for removal
9 operating unit for subsequent delivery
10 device
10G general purpose input/output (GPIO)
10L light sensor
10W scale
11 compartment, shelf
10S bar code scanner
12, 12B, 12F bar code
13 shelf trolley
14 worker
16 display
17 increment button/key
18 decrement button/key
19 acknowledgment button/key
20, 20K rack, shelf
21 container
22 light cone
24 RFID system
30 middleware
30₁, 30₂, . . . , 30_{K} services
40 IT area, user area
40₁, 40₂, . . . , 40_{M} data-providing and/or data-receiving elements
50 process area
51₁, 51₂, . . . , 51_{K} function modules
52₁, 52₂, . . . , 52_{L} device modules
53₁, 53₂, . . . , 53_{I} execution modules
54₁, 54₂, . . . , 54_{J} transitions
59 monitor for process visualization
60 configuration area
62 graphical user interface
63 monitor
64₁, 64₂, . . . , 64P devices for visualization
65 first subwindow
66 second subwindow
67 third subwindow
68 fourth subwindow
70 interface
71 input
72 output
73 WLAN communication
81 web page
82 video
83 field
84 dynamic cycle time
85 table
86 first status message field
87 second status message field
88 information field
89 image data
90 light barrier
91 Profinet/Profibus
92 potential-free inlet
93 RFID
94 A/D converter
95 PLC
96 modem
97 visual signal generator
98 speaker
99 potential-free outlet
100 system
110 process sequence
110LL warehouse logistics
110FL manufacturing logistics
110FP manufacturing process
120 master
130 slave
A, B product

What is claimed is:

1. A system for controlling, creating and modifying at least one process sequence from a warehouse logistics, a manufacturing logistics or a manufacturing process, the system comprising:
an IT area of a user, the IT area having a plurality of data-providing and/or data-receiving elements;
a process area, in which the at least one process sequence is implemented, which is composed of a plurality of execution modules composed of at least one selectable function module and/or at least one selectable device module;
a configuration area having at least one graphical user interface comprising a monitor subdivided into at least a first subwindow and a second subwindow, the first subwindow comprising a plurality of selectable function modules and a plurality of selectable device modules, and in the second subwindow at least one process sequence can be created, modified and visualized from the plurality of selectable function modules and the plurality of selectable device modules; and
middleware comprising a plurality of services communicatively connected to the data-providing and/or data-receiving elements of the IT area, the process area and the configuration area.

2. The system according to claim 1, wherein the execution modules of the at least one process sequence are interconnected by transitions.

3. The system according to claim 1, wherein the at least one process sequence comprises a master if at least one slave uses a communication protocol that does not permit direct communication with the middleware and wherein each master comprises a plurality of interfaces for connecting the slaves to the master, and the master is connected to at least one service of the middleware via a an interface.

4. The system according to claim 1, wherein a process sequence is configured such that all slaves communicate directly and instantly via a communication protocol with the middleware.

5. The system according to claim 3, wherein the slaves in the process sequences optionally comprise operating units for removal and/or operating units for subsequent delivery and/or devices.

6. A method for creating and modifying at least one process sequence of a warehouse logistics, a manufacturing logistics, or a manufacturing process, the method comprising the steps of:
creating or modifying at least one process sequence via a graphical user interface of a configuration area based on function modules and device modules, the at least one process sequence being made up of a plurality of execution modules; wherein the creation and/or modification of each process sequence is carried out such that at least one function module and at least one device module are selected from at least one first subwindow and displayed as the execution module in at least one second subwindow;
connecting the execution modules of a process sequence via transitions in the second subwindow to define the process sequence;
transferring the at least one process sequence to middleware and storing the at least one process sequence there; and
retrieving the at least one process sequence from the middleware for execution in a process area.

7. The method of claim 6, wherein in at least one third subwindow, properties and values are assigned to an execution module selected from the second subwindow.

8. The method according to claim 6, wherein the plurality of selectable device modules comprise a plurality of operating units for removal and/or operating units for subsequent delivery and/or various devices which act as slaves, the slaves being assigned with a plurality of properties or parameters the parameters being an IP address, a port, or a start character.

9. The method of claim 6, wherein the at least one process sequence is configured such that at least one slave of the at least one process sequence is communicatively connected with a master by using a communication protocol not allowing direct communication with the middleware, wherein the master comprises a plurality of interfaces and the master is connected to the middleware.

10. The method of claim 6, wherein the at least one process sequence is configured such that the slaves of the process sequence use a communication protocol allowing direct communication with the middleware, the slaves being directly connected with the middleware.

11. The method of claim 6, wherein the middleware is communicatively connected to an IT area of the user, and a bidirectional data exchange is performed between the IT area of the user and the middleware.

12. A computer program product for creating and modifying at least one process sequence of a warehouse logistics, a manufacturing logistics, or a manufacturing process, the computer program product having a plurality of program instructions stored on one or more computer-readable storage media, wherein:
at least one process sequence is defined on a graphical user interface on the basis of function modules and device modules stored in middleware, wherein a plurality of execution modules are composed of the function modules and/or the device modules, both of which are interconnected via transitions;
created process sequence is assigned to a process area and the middleware is communicatively connected to a process area; and
data from the at least one process sequence of the process area are sent via the middleware to data-providing and/or data-receiving elements of an IT area of a user, and data from the elements of the IT area are retrievable via the middleware from the at least one process sequence of the process area.

13. The computer program product according to claim 12, wherein the at least one process sequence can be displayed in a second subwindow of the graphical user interface and wherein the transitions and the plurality of execution modules are connected by arrows and define the at least one process sequence.
